(19) United States
(12) Patent Application Publication
(10) Pub. No.: US 2020/0009881 A1
(43) Pub. Date: Jan. 9, 2020

(54) PRINTING APPARATUS AND PRINTING METHOD

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 16/575,387

(22) Filed: Sep. 19, 2019

Related U.S. Application Data
(63) Continuation of application No. 15/105,579, filed on Jun. 17, 2016.

(30) Foreign Application Priority Data
Dec. 20, 2013 (JP) 2013-263447

(51) Int. Cl. B41J 11/00; B41J 2/21

(52) U.S. Cl. CPC B41J 11/002; B41J 2/2103

(57) ABSTRACT

The disclosure is to more appropriately perform high-quality printing in a case of using ultraviolet curing ink in a serial type inkjet printer. In a printing apparatus for performing printing in an inkjet mode, an inkjet head for Y color, an inkjet head for M color, temporarily hardening light sources, an inkjet head, and an inkjet head are arranged such that their positions in the sub scan direction are deviated from each other. With respect to each position on a medium, after the inkjet head ejects ink drops, the temporarily hardening light sources hardens the ultraviolet curing ink of the Y color on the medium, to a temporarily hardened state, before the inkjet head ejects ink drops, and then the inkjet head ejects ink drops of the M color onto the area where the ultraviolet curing ink of the Y color has hardened to the temporarily hardened state.

### CROSS-REFERENCE TO RELATED APPLICATIONS

This application is a continuation application of and claims priority benefit of a prior application Ser. No. 15/105,579, filed on Jun. 17, 2016, now pending, which also is a 371 application of international application of PCT application serial no. PCT/JP2014/083794, filed on Dec. 19, 2014, which claims the priority benefit of Japan application No. 2013-263447, filed on Dec. 20, 2013. The entirety of each of the above-mentioned patent applications is hereby incorporated by reference herein and made a part of this specification.

### TECHNICAL FIELD

The disclosure relates to a printing apparatus and a printing method.

### BACKGROUND ART

Inkjet printers for performing printing in an inkjet scheme according to the related art are being widely used. The inkjet printers eject ink drops from inkjet heads onto media, thereby forming ink dots on the media. These dots form individual pixels of print images. Also, as a configuration for an inkjet printer, a serial type configuration for controlling an inkjet head such that the inkjet head performs a main scan operation (a scanning operation) is being widely used. Also, as ink for inkjet printers, ultraviolet curing ink is being widely used.

### CITATION LIST

### Patent Literature

Patent Literature 1: JP-A-2012-45908

### SUMMARY

### Technical Problem

Recently, with demands for an improvement in print resolution and the like, the density of ink dots which are formed on media has increased. Also, with this, the distance between dots on medium has shortened, whereby dot contact (contact of dots) has become more likely to occur. However, for example, in a case where ink dots of different colors come into contact with each other, connection of the dots occurs, whereby the colors are mixed and bleeding (intercolor bleeding) occurs.

With respect to this, recently, printing in a multi-pass mode has been widely used as a printing method in inkjet printers. In the case of using a multi-pass mode, for example, it becomes possible to increase the distance between ink dots which are formed in one main scan operation. Also, in a case of using ultraviolet curing ink in an inkjet printer for performing printing in a multi-pass mode, generally, whenever the printer performs one main scan operation, the printer radiates ultraviolet light onto ink dots formed in the corresponding main scan operation, thereby hardening the dots. Therefore, according to this configuration, for example, it is possible to make contact of liquid ink dots unlikely to occur.

However, for example, in a case of performing printing in a state where a high printing rate has been set for increasing the density of ink dots which are formed on media, it may be difficult to completely prevent contact of liquid ink dots only by performing printing in a multi-pass mode. Therefore, bleeding or the like attributable to contact of dots may occur, and the quality of printing may decrease.

Also, in a case of using ultraviolet curing ink in an inkjet printer for performing printing in a multi-pass mode, during the second and subsequent passes, around the landing positions of ink dots, hardened ink dots have been already formed. In this case, the hardened state means a state where ink dots have fully hardened due to irradiation with a sufficient amount of ultraviolet light. Therefore, in this case, the hardened dots generally repel liquid ink. The state where the hardened dots repel liquid ink specifically means the state where the hardened dots are unlikely to get wet with ink which is in a liquid state before a hardening process. Therefore, ink dots which are newly formed spread only in directions in which there are no hardened dots. As a result, the shapes of ink dots which are newly formed are influenced by the surrounding hardened dots.

For this reason, in a case of using ultraviolet curing ink in an inkjet printer for performing printing in a multi-pass mode, for example, dot shapes may become uneven, and the quality of printing may decrease. Also, more specifically, in some cases such as a case of performing printing in a state where a high printing rate has been set, protruding ink dots hardened in an area having a narrow width may continue in one direction, whereby so-called hardened streaks and the like may occur.

For this reason, it has been required to perform printing by a more appropriate method in inkjet printers using ultraviolet curing ink. It is therefore an object of the disclosure to provide a printing apparatus and a printing method capable of solving the above described problems.

Also, during prior art search, the applicant of this application found Patent Literature 1 disclosing a configuration seemingly similar to the disclosure. However, the configuration disclosed in Patent Literature 1 is not a serial type configuration but a configuration for a so-called line printer. In contrast with this, the configuration of the disclosure is for solving problems and the like specific to serial type inkjet printers as described above or will be described below, and is different from the configuration of Patent Literature 1 in configurations which are their conditions.

### Solutions to Problem

In order to prevent occurrence of hardened streaks and so on, some methods such as a method of hardening ink dots at each position of a medium to a temporarily hardened state, without fully hardening the ink dots, by irradiation with weak ultraviolet light while printing is progressing can be considered. Also, in this case, irradiation with weak ultraviolet light is a convenient expression representing that irradiation with ultraviolet light is performed, for example, such that the total amount of ultraviolet light is smaller than the total amount of light required to fully harden ink dots. Therefore, other methods such as a method of performing irradiation with high-intensity ultraviolet light for a short time can also be considered. In this case, the intensity of irradiation with ultraviolet light means the amount of ultraviolet light which is used in irradiation for a predetermined unit time.

According to this configuration, for example, since there are no hardened dots while printing is progressing, it is possible to appropriately prevent the shapes of ink dots which are newly formed from being influenced by surrounding hardened dots. Therefore, it can be considered that it is possible to prevent occurrence of hardened streaks and so on. Further, since ink dots gradually flatten even after temporal hardening, it is possible to further uniformize the shapes of ink dots.

However, as described above, it is also necessary to sufficiently consider bleeding which is caused by contact of ink dots on media in inkjet printers. Further, even in the case of temporarily hardening ink dots as described above, if ink dots of different colors come into contact before irradiation with weak ultraviolet light, intercolor bleeding may occur and cause the quality of printing to decrease.

Here, with respect to such bleeding problem, it can be considered that, in serial type inkjet printers, it is only necessary to perform printing in a multi-pass mode, thereby increasing the distance between ink dots which are formed in one main scan operation, for example, similarly to inkjet printers according to the related art. However, in a case where an inkjet printer having a normal configuration according to the related art performs printing with ultraviolet curing ink in a multi-pass mode, in order to appropriately prevent intercolor bleeding and so on, whenever the printer performs each main scan operation, the printer needs to irradiate ink dots formed by the corresponding main scan operation, with ultraviolet light. For this reason, for example, even in a case of temporarily hardening ink dots, whenever the printer performs each main scan operation, the printer needs to perform irradiation with weak ultraviolet light, thereby temporarily hardening ink dots.

However, in a case of performing printing in a multi-pass mode, a plurality of main scan operations corresponding to multiple printing passes is performed on each position on a medium. For this reason, in a case of temporarily hardening ink dots, irradiation with weak ultraviolet light is also performed as many times as the number of printing passes. Therefore, in this case, each ink dot on a medium is irradiated with ultraviolet light, and the number of times of irradiation thereof varies depending on what number the printing pass during which the corresponding ink dot is formed is.

Therefore, in this case, for example, between ink dots formed during the first printing pass and ink dots formed during the last printing pass, a difference in the degree of hardening of ink increases. For this reason, for example, in a case of using a configuration identical to or similar to an inkjet printer according to the related art, it is practically difficult to set the amount of weak ultraviolet light such that it is possible to appropriately harden all of ink dots formed during the first and last printing passes, to a temporarily hardened state.

More specifically, for example, in a case of using ink of a plurality of colors (for example, ink of colors of C, M, Y, and K) in an inkjet printer according to the related art, it is necessary to form ink dots of the individual colors in each main scan operation. Therefore, in this configuration, the number of printing passes necessary to sufficiently prevent intercolor bleeding increases. For example, in case of a configuration in which ink dots are not formed at the positions of adjacent pixels in the same main scan operation in order to almost completely prevent intercolor bleeding, it is considered that about 24 to 36 passes are necessary. However, in this case, it is considered that a difference in the degree of hardening of ink between the first and last printing passes excessively increases. For this reason, in this configuration, it is practically difficult to appropriately harden all dots to a temporarily hardened state. Also, in this case, a decrease in printing speed attributable to the increase in the number of printing passes also becomes a problem.

As described above, in a case of using ultraviolet curing ink in a serial type inkjet printer, it may be impossible to appropriately perform high-quality printing only by using a configuration for temporarily hardening ink dots by irradiation with weak ultraviolet light. With respect to this, by more earnest researches, the inventor of this application found that it is possible to appropriately perform high-quality printing by making the layout of inkjet heads for different colors different from general configurations according to the related art. In order to achieve the above described object, the disclosure has the following configurations.

(First Configuration)

A printing apparatus which performs printing on a medium with an ultraviolet curing ink of N-number of different colors (N is an integer of 2 or greater) in an inkjet mode includes: a first-color head that is an inkjet head configured to eject first-color ink drops which are ink drops of the ultraviolet curing ink of a first color of the N-number of colors; a second-color head which is an inkjet head configured to eject second-color ink drops which are ink drops of the ultraviolet curing ink of a second color which is one of the N-number of colors and is different from the first color; a main scan driver configured to drive the first-color head and the second-color head to perform main scan operations of ejecting ink drops while moving in a predetermined main scan direction; a sub scan driver configured to relatively move the first-color head and the second-color head with respect to the medium in a sub scan direction perpendicular to the main scan direction; a temporarily hardening light source configured to radiate an ultraviolet light which hardens the ultraviolet curing ink on the medium to a temporarily hardened state which is a state where at least a surface of the ultraviolet curing ink has viscosity; and a fully hardening light source configured to radiate the ultraviolet light which completes hardening of the ultraviolet curing ink on the medium, wherein the first-color head and the second-color head are installed such that their positions in the sub scan direction are deviated from each other, and with respect to each position on the medium, the first-color head ejects the first-color ink drops in one of the main scan operations which is determined according to the position on the medium, and after the first-color head ejects the first-color ink drops, in another main scan operation, the second-color head ejects the second-color ink drops, and with respect to each position on the medium, after the first-color head ejects the first-color ink drops, the temporarily hardening light sources harden the ultraviolet curing ink of the first color on the medium, to the temporarily hardened state, before the second-color head ejects the second-color ink drops, and the second-color head ejects the second-color ink drops onto an area where the ultraviolet curing ink of the first color has hardened to the temporarily hardened state, and with respect to each position on the medium, after the second-color ink drops are ejected, the fully hardening light source radiates the ultraviolet light.

In this configuration, for example, ink dots of the first color which are formed on the medium are not fully hardened, and are hardened to the temporarily hardened state, whereby it is possible to make them a state where, even if they come into contact with liquid ink of other colors, bleeding does not occur, and they do not repel the liquid ink of other colors. Therefore, in the subsequent main scan operations, it is possible to appropriately form ink dots of the second color.

Therefore, according to this configuration, it is possible to appropriately prevent, for example, occurrence of intercolor bleeding, occurrence of hardened streaks, and so on. Also, it is possible to set the viscosity of ink in the temporarily hardened state to a degree of velocity at which ink dots gradually flatten as time goes on, for example, by irradiating the ink dots with weak ultraviolet light by the temporarily hardening light sources. Further, in this case, it is possible to sufficiently flatten the ink dots by setting a time interval between when temporal hardening is performed and when ultraviolet light is radiated by the fully hardening light source. Therefore, according to this configuration, for example, it also is possible to perform high-gross printing by sufficiently flattening ink dots.

Further, in this case, since the first-color head and the second-color head are installed such that their positions in the sub scan direction are deviated from each other, for example, it also is possible to reduce the number of colors of ink dots which are formed in each main scan operation. More specifically, for example, it is possible to set the number of colors of ink dots which are formed in each main scan operation, to a number smaller than N which is the number of all ink colors which are used. Therefore, it is possible to reduce the number of printing passes necessary to prevent, for example, intercolor bleeding and so on. Also, as a result, for example, with respect to the intensity of ultraviolet light which is radiated by the temporarily hardening light sources, even if it is considered that ultraviolet light is radiated a plurality of times by a plurality of printing passes, a settable range expands, whereby it becomes possible to appropriately set the intensity within a practical range. Therefore, according to this configuration, for example, in a case of using ultraviolet curing ink in a serial type inkjet printer, it is possible to more appropriately perform high-quality printing.

Also, in this configuration, for example, it can also be considered to install the inkjet heads for ejecting ink drops of the N-number of colors such that their positions in the sub scan direction do not overlap each other, and perform printing in a color-sequential mode in which the inkjet heads of the individual colors subsequently perform printing on each area of a medium. Further, in this case, even if printing is performed in a multi-pass mode without performing irradiation with ultraviolet light in each main scan operation, intercolor bleeding does not occur. Therefore, in this case, whenever printing corresponding to all printing passes is performed by the individual inkjet heads, ultraviolet light may be radiated by the temporarily hardening light sources. According to this configuration, it is possible to more appropriately set the intensity of ultraviolet light which is radiated by the temporarily hardening light sources. Therefore, for example, in a case of using ultraviolet curing ink in a serial type inkjet printer, it is possible to more appropriately perform high-quality printing.

(Second Configuration)

The printing apparatus performs printing in a multi-pass mode for performing printing on each position on the medium by a plurality of printing passes, and the first-color head and the second-color head are installed such that their positions in the sub scan direction are deviated from each other by a distance equal to or longer than a width of one printing pass in the sub scan direction.

This configuration is, for example, a configuration in which the number of colors of ink dots which are formed in a band area corresponding to each printing pass in each main scan operation is set to a number smaller than N. In this configuration, for example, it is possible to appropriately reduce the number of colors of ink dots which are formed in each main scan operation. Therefore, according to this configuration, for example, it is possible to more appropriately perform temporal hardening on ink dots which are formed by each printing pass. Therefore, for example, it is possible to appropriately perform high-quality printing.

Also, in this case, for example, during each printing pass, it is preferable that only one of the first-color head and the second-color head should eject ink drops onto a print target area on a medium. According to this configuration, for example, it is possible to more appropriately reduce the number of colors of ink dots which are formed in each main scan operation.

Also, for example, in a case where N is larger than 2, it can also be considered that both of the first-color head and the second-color head eject ink drops onto a print target area on a medium in main scan operations corresponding to some printing passes in a multi-pass mode. Even in this case, the number of colors of ink dots which are formed in a band area corresponding to each printing pass in each main scan operation is set to a number smaller than N. Also, in this case, a case where the first-color head ejects first-color ink drops, and then the second-color head ejects second-color ink drops in another main scan operation may be, for example, a case where the second-color head ejects second-color ink drops onto an area onto which first-color ink drops has been ejected in the previous main scan operation. Also, a case where the timing when the temporarily hardening light sources harden ultraviolet curing ink of the first color on a medium to the temporarily hardened state is after the first-color head ejects first-color ink drops and before the second-color head ejects second-color ink drops may be, for example, a case where the corresponding timing is after the first-color head ejects first-color ink drops onto each position on the medium in a predetermined main scan operation and before the second-color head ejects second-color ink drops in the next main scan operation. A case where the second-color head ejects second-color ink drops onto an area where ultraviolet curing ink of the first color has hardened to the temporarily hardened state may be, for example, a case where the second-color head ejects second-color ink drops onto an area where dots of ultraviolet curing ink of the first color formed in the previous main scan operation has hardened to the temporarily hardened state.

(Third Configuration)

Printing is performed in the multi-pass mode such that ink drops are not ejected onto adjacent pixels in the main scan direction by the same printing pass. According to this configuration, for example, it is possible to appropriately prevent liquid ink dots from coming into contact with each other. In this case, contact of liquid ink dots is contact of dots of ink having landed on a medium. Therefore, it is possible to prevent connection of ink dots and the like, and more appropriately uniformize the shapes of ink dots.

Also, since the contact angle of connected ink dots to a medium becomes large, it becomes easy for those ink dots to flatten in a shorter time. For this reason, if connection of ink dots occurs, it is easy for variation to occur even in the flatness of the ink dots and the like. In contrast with this, according to the above described configuration, for example, it is possible to more appropriately uniformize the degrees of flatness of ink dots. Also, for example, in a case where liquid ink dots of different colors come into contact with each other, the ink colors are mixed, and bleeding (intercolor bleeding) is likely to occur. In contrast with this, according to the above described configuration, it is also possible to appropriately prevent intercolor bleeding.

(Fourth Configuration)

The temporarily hardening light source waits for ink dots which are formed by the first-color ink drops having landed on the medium to flatten, and then harden the ultraviolet curing ink of the first color to the temporarily hardened state. According to this configuration, for example, it is possible to appropriately and sufficiently flatten ink dots. Therefore, for example, it is possible to more appropriately perform high-gross printing.

(Fifth Configuration)

The first-color head and the second-color head are installed side by side in the sub scan direction such that their positions in the sub scan direction do not overlap each other. In this configuration, for example, it is possible to appropriately reduce the number of colors of ink dots which are formed in each main scan operation. Therefore, according to this configuration, for example, it is possible to more appropriately perform temporal hardening on ink dots which are formed in each main scan operation. Therefore, for example, it is possible to appropriately perform high-quality printing.

Also, with respect to the positions of the first-color head and the second-color head, a case the positions in the sub scan direction do not overlap each other may be, for example, a case where the positions in the sub scan direction do not substantially overlap each other. The case where the positions in the sub scan direction do not substantially overlap each other may be, for example, a case where the positions of the nozzle rows of the first-color head and the second-color head in the sub scan direction do not overlap each other.

(Sixth Configuration)

The printing apparatus further includes: a third-color head that is an inkjet head configured to eject third-color ink drops which are ink drops of the ultraviolet curing ink of a third color different from both of the first color and the second color; and a fourth-color head that is an inkjet head configured to eject fourth-color ink drops which are ink drops of the ultraviolet curing ink of a fourth color different from all of the first color, the second color, and the third color, wherein the third-color head is aligned in the sub scan direction, and is installed side by side with the first-color head in the main scan direction, and the fourth-color head is aligned in the sub scan direction, and is installed side by side with the second-color head, and with respect to each position on the medium, the first-color head and the third-color head eject the first-color ink drops and the third-color ink drops, respectively, in a main scan operation which is determined according to the position on the medium, and after the first-color head and the third-color head eject the first-color ink drops and the third-color ink drops, in another main scan operation, the second-color head and the fourth-color head eject the second-color ink drops and the fourth-color ink drops, respectively, and with respect to each position on the medium, after the first-color head and the third-color head eject the first-color ink drops and the third-color ink drops, the temporarily hardening light sources harden the ultraviolet curing ink of the first color and the ultraviolet curing ink of the third color on the medium, to the temporarily hardened state, before the second-color head and the fourth-color head eject the second-color ink drops and the fourth-color ink drops, and the second-color head and the fourth-color head eject the second-color ink drops and the fourth-color ink drops onto an area where the ultraviolet curing ink of the first color and the third color has hardened to the temporarily hardened state.

In this configuration, for example, it is possible to appropriately reduce the number of colors of ink dots which are formed in each main scan operation. Therefore, according to this configuration, for example, it is possible to more appropriately perform temporal hardening on ink dots which are formed in each main scan operation. Therefore, for example, it is possible to appropriately perform high-quality printing.

(Seventh Configuration)

The printing apparatus further includes: a third-color head that is an inkjet head configured to eject third-color ink drops which are ink drops of the ultraviolet curing ink of a third color different from both of the first color and the second color; and a fourth-color head that is an inkjet head configured to eject fourth-color ink drops which are ink drops of the ultraviolet curing ink of a fourth color different from all of the first color, the second color, and the third color, wherein the printing apparatus performs printing in a multi-pass mode for performing printing on each position on the medium by a plurality of printing passes, and the first-color head, the second-color head, the third-color head, and the fourth-color head are installed in this order, side by side in the main scan direction, such that their positions in the sub scan direction are sequentially deviated from each other by a distance which is a product of an integer and a pass width which is the width of one printing pass in the sub scan direction.

In this configuration, for example, in each main scan operation, it is possible to appropriately reduce the number of colors of ink dots which are formed in a band area corresponding to each printing pass. Therefore, according to this configuration, for example, it is possible to more appropriately perform temporal hardening on ink dots which are formed in each main scan operation. Therefore, for example, it is possible to appropriately perform high-quality printing.

(Eighth Configuration)

The printing apparatus performs printing in a multi-pass mode for performing printing on each position on the medium by a plurality of printing passes, and performs printing in the multi-pass mode such that ink drops of different colors are not ejected onto any of the same pixel and adjacent pixels in the main scan direction in the same printing pass.

According to this configuration, for example, with respect to ink dots of different colors, it is possible to more appropriately prevent liquid dots from coming into contact with each other. Therefore, it is possible to more appropriately prevent intercolor bleeding.

(Ninth Configuration)

The intensity of the ultraviolet light which the temporarily hardening light source radiates is lower than the intensity of the ultraviolet light which the fully hardening light source radiates. According to this configuration, for example, it is possible to appropriately perform temporal hardening on ink dots. It is preferable to set the intensity of ultraviolet light which the temporarily hardening light sources radiate, to 1/20 to ⅓ of the intensity of ultraviolet light which the fully hardening light source radiates. Also, it is more preferable to set the intensity of ultraviolet light which the temporarily hardening light sources radiate, to 1/10 to ¼ of the intensity of ultraviolet light which the fully hardening light source radiates.

(Tenth Configuration)

The N-number of colors are divided into k-number of groups (k is an integer equal to or greater than 2 and less than N) each of which includes one or more colors, and positions of inkjet heads for ejecting ink drops of colors included in each group are installed so as not to overlap positions of inkjet heads for ejecting ink drops of colors included in the other groups, in the sub scan direction. It is preferable to set “k” to, for example, 2 or 3.

In this configuration, for example, it is possible to appropriately reduce the number of colors of ink dots which are formed in each main scan operation. Therefore, according to this configuration, for example, it is possible to more appropriately perform temporal hardening on ink dots which are formed in each main scan operation. Therefore, for example, it is possible to appropriately perform high-quality printing.

(Eleventh Configuration)

Each of the first-color head and the second-color head has a plurality of nozzle rows, in each of which a plurality of nozzles is arranged in line in the sub scan direction. The plurality of nozzle rows is arranged side by side, for example, in the main scan direction. Also, in this case, it is preferable that each of the inkjet heads for all of the N-number of colors should have a plurality of nozzle rows.

In this configuration, for example, each of the inkjet heads of the individual colors can eject ink drops from the nozzles of the plurality of nozzle rows onto the same area on a medium in each main scan operation. Therefore, according to this configuration, for example, by one main scan operation, it is possible to perform printing identical or similar to printing by as many printing passes as the number of the nozzle rows.

(Twelfth Configuration)

A printing method of performing printing on a medium with an ultraviolet curing ink of N-number of different colors (N is an integer of 2 or greater) in an inkjet mode uses: a first-color head that is an inkjet head configured to eject first-color ink drops which are ink drops of the ultraviolet curing ink of a first color of the N-number of colors; a second-color head which is an inkjet head configured to eject second-color ink drops which are ink drops of the ultraviolet curing ink of a second color which is one of the N-number of colors and is different from the first color; a main scan driver configured to drive the first-color head and the second-color head to perform main scan operations of ejecting ink drops while moving in a predetermined main scan direction; a sub scan driver configured to relatively move the first-color head and the second-color head with respect to the medium in a sub scan direction perpendicular to the main scan direction; a temporarily hardening light source configured to radiate an ultraviolet light which hardens the ultraviolet curing ink on the medium to a temporarily hardened state which is a state where at least a surface of the ultraviolet curing ink has viscosity; and a fully hardening light source configured to radiate the ultraviolet light which completes hardening of the ultraviolet curing ink on the medium, wherein the first-color head and the second-color head are installed such that their positions in the sub scan direction are deviated from each other, and with respect to each position on the medium, the first-color head ejects the first-color ink drops in one of the main scan operations which is determined according to the position on the medium, and after the first-color head ejects the first-color ink drops, in another main scan operation, the second-color head ejects the second-color ink drops, and with respect to each position on the medium, after the first-color head ejects the first-color ink drops, the temporarily hardening light sources harden the ultraviolet curing ink of the first color on the medium, to the temporarily hardened state, before the second-color head ejects the second-color ink drops, the second-color head ejects the second-color ink drops onto an area where the ultraviolet curing ink of the first color has hardened to the temporarily hardened state, and with respect to each position on the medium, after the second-color ink drops are ejected, the fully hardening light source radiates the ultraviolet light. According to this configuration, for example, it is possible to achieve the same effects as those of the first configuration.

(Thirteenth Configuration)

A printing apparatus which performs printing on a medium with an ultraviolet curing ink of N-number of different colors (N is an integer of 2 or greater) in an inkjet mode, includes: N-number of inkjet heads configured to eject ink drops of the ultraviolet curing ink of the N-number of colors, respectively; a main scan driver configured to drive the N-number of inkjet heads to perform main scan operations of ejecting ink drops while moving in a predetermined main scan direction; a sub scan driver configured to relatively move the N-number of inkjet heads with respect to the medium in a sub scan direction perpendicular to the main scan direction; a temporarily hardening light source configured to radiate an ultraviolet light which hardens the ultraviolet curing ink on the medium to a temporarily hardened state which is a state where at least a surface of the ultraviolet curing ink has viscosity; and a fully hardening light source configured to radiate the ultraviolet light which completes hardening of the ultraviolet curing ink on the medium, wherein the printing apparatus performs printing in a multi-pass mode for performing printing on each position on the medium by a plurality of printing passes, and the N-number of inkjet heads are installed such that the number of colors of ink dots which are formed in a band area corresponding to each printing pass in each main scan operation is smaller than N, and with respect to ink dots formed at each position on the medium in each main scan operation, the temporarily hardening light sources harden the ink dots to the temporarily hardened state before the next main scan operation on the same position is performed, and with respect to each position on the medium, after all main scan operations of ejecting ink drops onto the corresponding position are performed, the fully hardening light source radiates the ultraviolet light.

The N-number of inkjet heads are installed, for example, such that their positions in the sub scan direction are deviated from each other. In this configuration, for example, in each main scan operation, it is possible to appropriately reduce the number of colors of ink dots which are formed in a band area corresponding to each printing pass. Therefore, according to this configuration, for example, it is possible to more appropriately perform temporal hardening on ink dots which are formed in each main scan operation. Therefore, for example, it is possible to appropriately perform high-quality printing. Further, for example, it is possible to achieve the same effects as those of the first configuration.

(Fourteenth Configuration)

A printing method of performing printing on a medium with an ultraviolet curing ink of N-number of different colors (N is an integer of 2 or greater) in an inkjet mode uses: N-number of inkjet heads configured to eject ink drops of the ultraviolet curing ink of the N-number of colors, respectively; a main scan driver configured to drive the N-number of inkjet heads to perform main scan operations of ejecting ink drops while moving in a predetermined main scan direction; a sub scan driver configured to relatively move the N-number of inkjet heads with respect to the medium in a sub scan direction perpendicular to the main scan direction; a temporarily hardening light source configured to radiate an ultraviolet light which hardens ultraviolet curing ink on the medium to a temporarily hardened state which is a state where at least a surface of the ultraviolet curing ink has viscosity; and a fully hardening light source configured to radiate the ultraviolet light which completes hardening of the ultraviolet curing ink on the medium, and printing is performed in a multi-pass mode for performing printing on each position on the medium by a plurality of printing passes, and the N-number of inkjet heads are installed such that the number of colors of ink dots which are formed in a band area corresponding to each printing pass in each main scan operation is smaller than N, and with respect to ink dots formed at each position on the medium in each main scan operation, the temporarily hardening light sources harden the ink dots to the temporarily hardened state before the next main scan operation on the same position is performed, and with respect to each position on the medium, after all main scan operations of ejecting ink drops onto the corresponding position are performed, the fully hardening light source radiates the ultraviolet light. According to this configuration, for example, it is possible to achieve the same effects as those of the thirteenth configuration.

### Advantageous Effects of Invention

According to the disclosure, in a case of using ultraviolet curing ink in a serial type inkjet printer, it is possible to more appropriately perform high-quality printing.

### BRIEF DESCRIPTION OF DRAWINGS

FIG. 1(a) and FIG. 1(b) are views illustrating an example of a printing apparatus 10 according to an embodiment of the disclosure. FIG. 1(a) and FIG. 1(b) are a front view and a top view illustrating an example of the configuration of a main portion of the printing apparatus 10.

FIG. 2 is a view illustrating an example of a more specific configuration of an ink dot former 12.

FIG. 3(a)-FIG. 3(c) are schematic views illustrating examples of the relation between ink dots which are newly formed on a medium and the surrounding dots having been already formed. FIG. 3(a) shows an example of a state in a case where the surrounding dots are in a liquid state. FIG. 3(b) shows an example of a state in a case where the surrounding dots have already hardened to become a solid state. FIG. 3(c) shows an example of a state in a case where the surrounding dots are in a temporarily hardened state.

FIG. 4 is a graph illustrating an example of the relation between the amount of irradiation with ultraviolet light (the total amount of light) and the hardened state of ultraviolet curing ink.

FIG. 5(a) and FIG. 5(b) are views illustrating modifications of the configuration of the ink dot former 12. FIG. 5 (a) shows a first modification of the configuration of the ink dot former 12. FIG. 5(b) shows a second modification of the configuration of the ink dot former 12.

FIG. 6(a)-FIG. 6(c) are views illustrating other modifications of the configuration of the ink dot former 12. FIG. 6(a) shows a third modification of the configuration of the ink dot former 12. FIG. 6(b) shows a fourth modification of the configuration of the ink dot former 12. FIG. 6(c) shows a fifth modification of the configuration of the ink dot former 12.

FIG. 7(a) and FIG. 7(b) are views illustrating other modifications of the ink dot former 12. FIG. 7(a) shows a sixth modification of the configuration of the ink dot former 12. FIG. 7(b) shows a seventh modification of the configuration of the ink dot former 12.

FIG. 8(a) and FIG. 8(b) are views for explaining an example of a configuration and an operation in a case of using an inkjet head 202 having a plurality of nozzle rows 302. FIG. 8(a) shows an example of the configuration of the inkjet head 202. FIG. 8(b) shows an example of a printing operation which is performed with the inkjet head 202.

### DESCRIPTION OF EMBODIMENTS

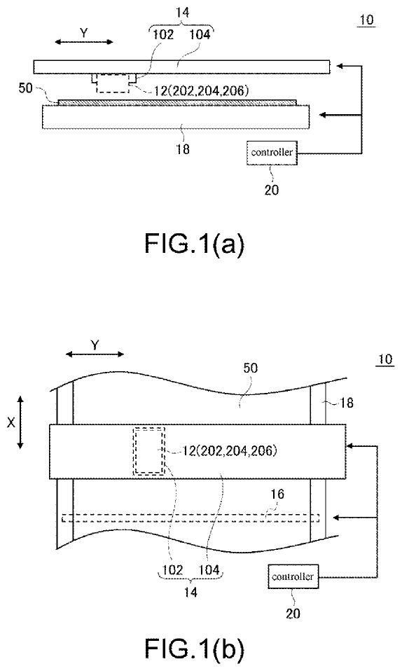

Hereinafter, embodiments according to the disclosure will be described with reference to the drawings. FIG. 1(a) and FIG. 1(b) show an example of a printing device 10 according to an embodiment of the disclosure. FIG. 1 (a) and FIG. 1(b) are a front view and a top view illustrating an example of the configuration of a main portion of the printing device 10. Also, the printing device 10 may have a configuration identical or similar to that of a known inkjet printer, except for points to be described below.

The printing apparatus 10 is an inkjet printer for performing printing in a serial mode in which an inkjet head performs main scan operations. Also, in the present embodiment, the printing apparatus 10 is an inkjet printer for performing printing on a medium 50 with ultraviolet curing ink of N-number of different colors (wherein N is an integer of 2 or greater) in an inkjet mode, and includes an ink dot former 12, a main scan driver 14, a sub scan driver 16, a platen 18, and a controller 20.

The ink dot former 12 is a part for performing printing on a medium 50 by forming ink dots corresponding to individual pixels of a print image on the medium 50. In the present embodiment, the ink dot former 12 includes inkjet heads 202, temporarily hardening light sources 204, and a fully hardening light source 206.

The inkjet head 202 is a print head for ejecting ink drops of ultraviolet curing ink onto the medium 50. In the present embodiment, the ink dot former 12 has N-number of inkjet heads 202 corresponding to ultraviolet curing ink of N-number of colors for printing. Also, each of the inkjet heads 202 has, for example, nozzle rows in which nozzles for ejecting ink drops are arranged in line in a predetermined direction.

Also, in the present embodiment, the ultraviolet curing ink is, for example, ink which hardens by irradiation with ultraviolet light. The ultraviolet curing ink may be, for example, ink containing a monomer or an oligomer or the like together with a polymerization initiator which reacts to ultraviolet light. Also, the ultraviolet curing ink may further contain, for example, various known additives or the like. In the present embodiment, as the ultraviolet curing ink, for example, known ultraviolet curing ink can be suitably used. Also, it can be also considered to use ultraviolet curing ink containing an organic solvent or water, such as so-called solvent UV ink or water-based UV ink, as the ultraviolet curing ink of the present embodiment.

The temporarily hardening light source 204 is an ultraviolet light source for radiating ultraviolet light for hardening ultraviolet curing ink on a medium 50 to a temporarily hardened state. The temporarily hardened state is, for example, a state where ink has hardened to a state where at least its surface has adhesion. The temporarily hardened state may be, for example, a state where hardening of ultraviolet curing ink has progressed to some extent. Also, more specifically, in the present embodiment, the temporarily hardened state is, for example, a state where ultraviolet curing ink does not repel liquid ink of different colors without occurrence of bleeding even if coming into contact with the liquid ink of different colors. The temporarily hardened state may be, for example, a state where viscosity has increased to 1000 mPa·sec to 500000 mPa·sec.

The fully hardening light source 206 is an ultraviolet light source for radiating ultraviolet light for completion of hardening (fully hardening) of ultraviolet curing ink on a medium 50. As the temporarily hardening light sources 204 and the fully hardening light source 206, for example, UVLED can be suitably used. According to the above described configuration, the ink dot former 12 forms ink dots on each medium 50. Also, a more specific configuration of the ink dot former 12 will be described in detail below.

The main scan driver 14 is a component for making the inkjet heads 202 of the ink dot former 12 perform main scan operations of ejecting ink drops while moving in a predetermined main scan direction (a Y direction in the drawings). In the present embodiment, the main scan driver 14 includes a carriage 102 and a guide rail 104. The carriage 102 holds the ink dot former 12 such that the nozzle rows of the inkjet heads 202 and a medium 50 face each other. Also, in the present embodiment, the carriage 102 holds the ink dot former 12 such that the nozzle rows extend in a sub scan direction (an X direction in the drawings) perpendicular to the main scan direction. The guide rail 104 is a rail for guiding movement of the carriage 102 in the main scan direction, and moves the carriage 102 in the main scan direction in response to an instruction of the controller 20.

The sub scan driver 16 is a component for making the inkjet heads 202 of the ink dot former 12 perform sub scan operations in which they relatively move in the sub scan direction with respect to a medium 50. In the present embodiment, the sub scan driver 16 is a roller for conveying each medium 50, and conveys a medium 50 during intervals between main scan operations, thereby making the inkjet heads 202 perform sub scan operations.

Further, for example, it can also be considered to use a configuration for performing sub scan operations by moving the inkjet heads 202 with respect to a medium 50 fixed in place (for example, an X-Y table type apparatus), as the configuration of the printing apparatus 10. In this case, as the sub scan driver 16, for example, a driver or the like for moving the inkjet heads 202 by moving the guide rail 104 in the sub scan direction can be used.

The platen 18 is a board-like member for mounting a medium 50, and supports a medium 50 such that the medium faces the nozzle surfaces of the inkjet heads 202 of the ink dot former 12 having the nozzles formed therein. Also, on the platen 18, for example, some components such as a heater for heating each medium 50 may be installed. According to this configuration, in some cases, such as a case where the ultraviolet curing ink contains a solvent, it is possible to quickly increase the viscosity of the ink by removing the solvent. Also, in this way, it is possible to further reduce the intensity of ultraviolet light necessary to semi-harden ultraviolet curing ink. The controller 20 is, for example, a CPU of the printing apparatus 10, and controls the operation of each unit of the printing apparatus 10, for example, in response to instructions of a host PC. According to the above described configuration, the printing apparatus 10 performs printing on each medium 50.

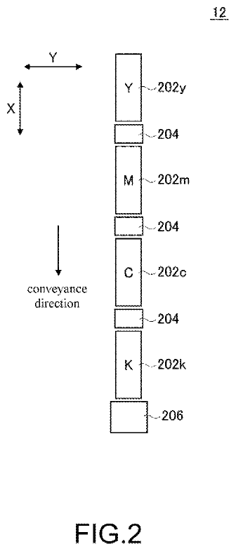

Now, a more specific configuration of the ink dot former 12 will be described in detail. FIG. 2 shows an example of a more specific configuration of the ink dot former 12.

As described above, in the present embodiment, the ink dot former 12 has the N-number of inkjet heads 202 corresponding to the ultraviolet curing ink of N-number of colors. Also, more specifically, with respect to a case of using ultraviolet curing ink of individual colors of C, M, Y, and K in the printing apparatus 10 (see FIG. 1), FIG. 2 shows a configuration in a case of having a plurality of inkjet heads 202y, 202m, 202c, and 202k (hereinafter, referred to as the inkjet heads 202y to 202k) for ejecting ink of the individual colors C, M, Y, and K.

Also, in the configuration shown in FIG. 2, the Y (yellow) color is an example of a first color of the N-number of colors. The M (magenta) color is an example of a second color which is one of the N-number of colors and is different from the first color. Also, the inkjet head 202y is an example of a first-color head for ejecting first-color ink drops of ultraviolet curing ink of the first color. The inkjet head 202m is an example of a second-color head which is an inkjet head which is installed such that the position is deviated from the first-color head in the sub scan direction and ejects second-color ink drops which are ink drops of ultraviolet curing ink of the second color. Also, in a modification of the configuration of the printing apparatus 10, the ink dot former 12 may further include inkjet heads 202 for colors other than C, M, Y, and K. For example, the ink dot former 12 may further include inkjet heads 202 for W (white), CL (clear) and other specific colors.

Also, in the present embodiment, the inkjet heads 202y to 202k for ejecting ink drops of the individual different colors are installed such that their positions in the sub scan direction are deviated from each other. More specifically, in the configuration shown in FIG. 2, the inkjet heads 202y to 202k are installed side by side in the sub scan direction such that their positions in the sub scan direction do not overlap each other. In this way, the inkjet heads 202y to 202k are sequentially arranged side by side along a medium conveyance direction of a sub scan operation.

In this configuration, in each main scan operation, the inkjet heads 202y to 202k eject ink drops onto different areas of a medium, respectively. Also, onto the same area of a medium, the inkjet heads eject ink drops of the individual colors in different main scan operations which are performed alternately with sub scan operations. More specifically, for example, onto each position of a medium, the inkjet head 202y ejects ink drops of the Y color in a main scan operation which is determined according to the corresponding position on the medium. Also, after the inkjet head 202y ejects ink drops of the Y color onto an area, in another main scan operation, the inkjet head 202m ejects ink drops of the M color onto the area onto which the inkjet head 202y has ejected the ink drops of the Y color. Also, onto this area, the inkjet head 202c and the inkjet head 202k eject ink drops of the C color and the K color in subsequent different main scan operations. In this way, the inkjet heads 202y to 202k perform printing in a color-sequential mode in which the inkjet heads of the individual colors sequentially perform printing on each area of a medium.

Also, in the present embodiment, the ink dot former 12 includes the plurality of temporarily hardening light sources 204. As shown in FIG. 2, each of the plurality of temporarily hardening light sources 204 is installed between the inkjet heads 202y to 202k in the sub scan direction. In this case, the individual temporarily hardening light sources 204 radiate low-intensity ultraviolet light which does not fully harden ink, onto ultraviolet curing ink ejected onto a medium by the inkjet heads installed on the upstream side from the temporarily hardening light sources 204 in the medium conveyance direction. In this way, the temporarily hardening light sources 204 harden the ultraviolet curing ink on the medium to the temporarily hardened state.

More specifically, for example, in case of a temporarily hardening light source 204 installed between the inkjet head 202y and the inkjet head 202m, after the inkjet head 202y ejects ink drops of the Y color onto each position on a medium, the corresponding light source hardens the ultraviolet curing ink of the Y color on the medium to the temporarily hardened state before the inkjet head 202m ejects ink drops of the M color. Therefore, thereafter, the inkjet head 202m ejects ink drops of the M color onto the area where the ultraviolet curing ink of the Y color has hardened to the temporarily hardened state. Also, the other temporarily hardening light sources 204 installed at different positions radiate ultraviolet light at the same timing as the timings of the operations of inkjet heads positioned on the upstream side and downstream side in the conveyance direction.

Also, in the present embodiment, the ink dot former 12 includes the fully hardening light source 206 on the downstream side from the inkjet heads 202y to 202k in the medium conveyance direction. Therefore, the fully hardening light source 206 radiates intense ultraviolet light for completing hardening of ultraviolet curing ink, onto each position on a medium, after ink drops of all the colors are ejected onto the corresponding position.

According to the present embodiment, printing is performed in the color-sequential mode, and ink is hardened to the temporarily hardened state, whereby it is possible to appropriately prevent, for example, ink dots of different colors from coming into contact with each other on a medium when the ink dots are in a liquid state having low viscosity and high fluidity. Therefore, it is possible to appropriately prevent intercolor bleeding or the like which is caused by ink of different colors being mixed.

Also, in the present embodiment, as described above, the fully hardening light source 206 radiates intense ultraviolet light for completing hardening of ultraviolet curing ink, after ink drops of all the colors are ejected. Therefore, it is possible to appropriately prevent liquid ink from being repelled by ink dots formed early, during printing using the inkjet heads 202y to 202k. Therefore, it is possible to appropriately prevent hardened streaks or the like which is caused by, for example, protruding ink dots having hardened in an area having a narrow width continuing in one direction. Therefore, according to the present embodiment, it is possible to more appropriately perform printing, for example, in the color-sequential mode.

Also, it is possible to set the viscosity of ink in the temporarily hardened state to a degree of viscosity at which the ink dots gradually flatten as time goes on, for example, by irradiating the ink dots with weak ultraviolet light by the temporarily hardening light sources 204. Further, in this case, for example, it is possible to sufficiently flatten the ink dots by setting a time interval between when temporal hardening is performed and when irradiation with ultraviolet light is performed by the fully hardening light source 206. Therefore, according to the present embodiment, for example, it is possible to perform high-gross printing by sufficiently flattening ink dots.

Further, according to the present embodiment, the temporarily hardening light sources 204 are formed between the inkjet heads 202y to 202k, whereby, for example, it also is possible to appropriately and sufficiently set a time interval between when ink drops land and when irradiation with ultraviolet light is performed by the temporarily hardening light sources 204. In this case, it is preferable that the temporarily hardening light sources 204 should harden ultraviolet curing ink to the temporarily hardened state after waiting for ink dots which are formed by ink drops having landed on a medium to flatten. In this case, it can be considered to make the temporarily hardening light sources 204 radiate ultraviolet light, for example, when several seconds to several tens seconds elapse after ink drops lands on the medium. According to this configuration, for example, it is possible to appropriately and sufficiently flatten ink drops. Therefore, for example, it is possible to more appropriately perform high-gross printing.

As described above, according to the present embodiment, for example, in a case of using ultraviolet curing ink in a serial type inkjet printer, it is possible to appropriately prevent problems such as intercolor bleeding and hardened streaks. Therefore, for example, it is possible to more appropriately perform high-quality printing.

Also, as described above, in the present embodiment, the printing apparatus 10 performs sub scan operations by conveying each medium. Further, in this case, as shown in some drawings, the medium conveyance direction becomes parallel with the sub scan direction. For this reason, in this case, with respect to the layout of the inkjet heads 202y to 202k and so on, it can be said that they are installed side by side in the conveyance direction of the medium 50. Also, in a modification of the configuration of the printing apparatus 10, for example, it can be also considered to perform sub scan operations by moving the inkjet heads 202y to 202k. In this case, for example, it is preferable to install the inkjet heads 202y to 202k, the temporarily hardening light sources 204, and the fully hardening light source 206 such that the direction of relative movement of each component to a medium becomes the same as that shown in FIG. 2.

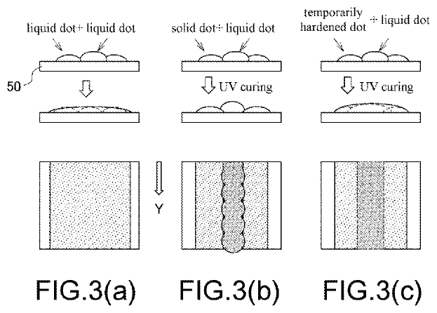

Now, a state where ultraviolet curing ink hardens on a medium will be described in more detail. FIG. 3(a)-FIG. 3(c) are schematic views illustrating examples of the relation between ink dots which are newly formed on a medium and the surrounding dots having been already formed, with respect to the state of hardening of ultraviolet curing ink, and simply shows examples of cases where the surrounding dots are in a liquid, solid, or temporarily hardened state for explanation. FIG. 3(a) shows an example of a state in a case where the surrounding dots are in the liquid state. FIG. 3(b) shows an example of a state in a case where the surrounding dots have been already hardened to become the solid state. FIG. 3(c) shows an example of a state in a case where the surrounding dots are in the temporarily hardened state.

As shown in FIG. 3(a)-FIG. 3(c), the state of the ink dots which are newly formed on the medium is significantly different from the state of the surrounding dots already formed. For example, as shown in FIG. 3(a), in the case where the surrounding dots are in the liquid state, the ink dots which are newly formed are connected with the surrounding dots, thereby integrating with the surrounding dots. For this reason, for example, in a case where the surrounding dots are ink dots of different colors, intercolor bleeding occurs. Also, in this case, since the contact angle with the medium becomes large, the ink dots flatten in a short time.

Also, as shown in FIG. 3(b), in the case where the surrounding dots have already hardened to become the solid state, the ink of the ink dots which are newly formed are repelled by the surrounding dots. For this reason, in this case, it becomes easy for the ink dots which are newly formed to protrude due to a decrease in width. Also, as a result, in some cases such as a case of performing printing when a high printing rate has been set, it becomes easy for hardened streaks to occur.

In contrast with this, as shown in FIG. 3(c), in the case where the surrounding dots are in the temporarily hardened state, as described in association with FIGS. 1(a), 1(b) and 2 and the like, the surrounding dots become a state where they are not connected with other dots and do not repel liquid ink. For this reason, in this case, even if new dots are formed, bleeding and hardened streaks do not occur. Also, in this case, for example, with respect to the surrounding dots and the dots which are newly formed, it is possible to flatten the ink dots according to a degree of hardening to which the ink dots are temporarily hardened.

However, this preferable hardening state can be implemented only when the amount of irradiation with ultraviolet light is constant. For this reason, it is necessary to appropriately set the amount of irradiation with ultraviolet light which is performed by the temporarily hardening light sources 204 (see FIG. 2), according to the properties of the used ultraviolet curing ink. Now, this point will be described in more detail.

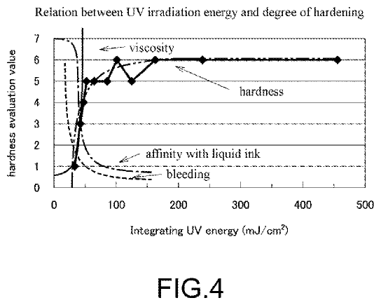

FIG. 4 is a graph illustrating an example of the relation between the amount of irradiation with ultraviolet light (the total amount of light) and the hardened state of ultraviolet curing ink, and shows examples of the states of the viscosity of ink, the hardness of ink, easiness of occurrence of bleeding of ink, and the affinity of ink with liquid ink, with respect to the amount of irradiation with ultraviolet light. As shown by the graph, if the amount of irradiation with ultraviolet light (the total amount of light) increases, the viscosity of ink increases, and hardening progresses. Also, if the amount of irradiation with ultraviolet light increases, the easiness of bleeding of ink decreases. Meanwhile, the affinity with liquid ink decreases if the amount of irradiation with ultraviolet light increases.

Also, all of these individual properties vary steeply after the amount of irradiation with ultraviolet light reaches a certain amount, as shown by the graph. Further, in order to harden ultraviolet curing ink to the temporarily hardened state desirable as described above, generally, it becomes necessary to set the amount of irradiation with ultraviolet light within a range in which those individual properties vary steeply.

In the present embodiment, as described in association with FIG. 2 and the like, with respect to the ultraviolet curing ink of the plurality of colors, printing is performed in the color-sequential mode. In contrast with this, in inkjet printers according to the related art, a configuration in which inkjet heads for different colors are installed in line in a main scan direction and ink drops of all the colors are ejected in each main scan operation is being widely used. Further, in this case, since ink dots of the individual colors are formed by the same main scan operation, it can be said that an intercolor bleeding problem is likely to occur. For this reason, in this case, in order to appropriately set the amount of irradiation with ultraviolet light for hardening to the temporarily hardened state, it is necessary to sufficiently consider, for example, the easiness of occurrence of bleeding and so on as shown by the graph of FIG. 4.

Also, in the case of the configuration in which ink dots of individual colors are formed by the same main scan operation, in order to prevent intercolor bleeding, it is considered that, at least, it is necessary to perform printing in a multi-pass mode, and perform irradiation with ultraviolet light whenever each main scan operation is performed. Also, in this case, irradiation of each position on a medium with ultraviolet light is performed at least as many times as the number of printing passes. Therefore, in this case, each ink dot on a medium is irradiated with ultraviolet light, the number of times of irradiation thereof varies depending on what number the printing pass during which the corresponding ink dot is formed is. As a result, in this case, for example, between ink dots formed during the first printing pass and ink dots formed during the last printing pass, a difference in the degree of hardening of ink is generated.

Also, in case of the configuration according to the related art as described above, in order to appropriately prevent intercolor bleeding, it becomes necessary to sufficiently increase the number of printing passes. Further, in this case, with the increase in the number of passes, the printing time may significantly increase. Also, in this case, it is considered that a difference in the degree of hardening between the first and last printing passes excessively increases. Further, in this case, it is not easy to appropriately perform temporal hardening on ink dots during all of the first to last printing passes.

In contrast with this, in the present embodiment, as described above, printing is performed by the color-sequential mode. For this reason, in each main scan operation, intercolor bleeding does not occur. Therefore, it is not necessarily needed to irradiate ultraviolet light whenever each main scan operation is performed. For this reason, according to the present embodiment, for example, it becomes possible to more easily and appropriately set the intensity of ultraviolet light which is radiated by the temporarily hardening light sources 204 (see FIG. 2) in order to temporarily harden ink dots, within a practical range. Therefore, for example, it is possible to more appropriately perform high-quality printing.

Also, it is considered to set the intensity of ultraviolet light which the temporarily hardening light sources 204 radiate, for example, to 1/20 to ⅓ of the intensity of ultraviolet light which the fully hardening light source 206 (see FIG. 2) radiates. Also, it is more preferable to set the intensity of ultraviolet light which the temporarily hardening light sources 204 radiate, for example, to 1/10 to ¼ of the intensity of ultraviolet light which the fully hardening light source 206 radiates.

Also, in the present embodiment, printing may be performed, for example, in the multi-pass mode. In this case, it is preferable to perform printing in the multi-pass mode such that ink drops are not ejected onto adjacent pixels in the main scan direction during the same printing pass. According to this configuration, for example, it is possible to more appropriately prevent liquid ink dots from coming into contact with each other. Therefore, it is possible to prevent connection of ink dots and the like, and more appropriately uniformize the shapes of ink dots.

Also, since the contact angle of connected ink dots to a medium becomes large, it becomes easy for those ink dots to flatten in a shorter time. For this reason, if connection of ink dots occurs, it is easy for variation to occur even in the flatness of the ink dots. With respect to this, according to this configuration, for example, it is possible to more appropriately uniformize the degrees of flatness of ink dots.

Here, as described above, for example, the configuration shown in FIG. 2 is not a configuration in which ultraviolet light is radiated whenever each main scan operation is performed. Therefore, for example, even if printing is performed in a multi-pass mode, a difference in the degree of dot hardening between the first and last printing passes is not generated. With respect to this, for example, in a modification of the ink dot former 12 (see FIG. 2), it can also be considered to use a configuration in which ultraviolet light is radiated whenever each main scan operation is performed. However, even in this case, since printing is performed in the color-sequential mode, and it is unnecessary to consider intercolor bleeding, it is possible to appropriately reduce the intensity of ultraviolet light which is radiated during each main scan operation. Also, since it is unnecessary to consider intercolor bleeding, it is possible to reduce the number of necessary printing passes. Therefore, even in this case, it is considered that it is possible to more easily and appropriately set the intensity of ultraviolet light for temporal hardening.

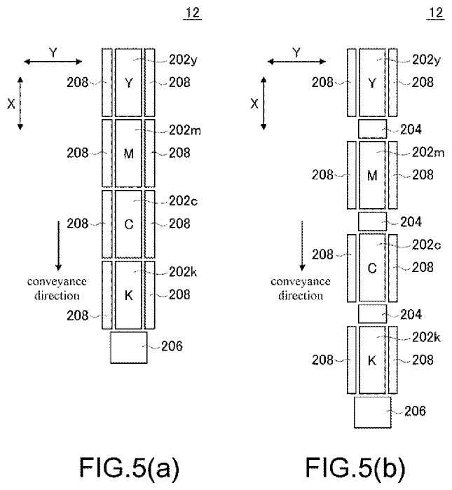

Now, various modifications of the configuration of the ink dot former 12 will be described. FIG. 5(a) and FIG. 5(b) show modifications of the configuration of the ink dot former 12. Also, in FIG. 5(a) and FIG. 5(b), components denoted by the same reference symbols as those of FIGS. 1(a), 1(b) to 4 have features identical or similar to the components of FIGS. 1(a), 1(b) to 4, except for points to be described below.

FIG. 5(a) shows a first modification of the configuration of the ink dot former 12. In the present modification, the ink dot former 12 has a plurality of temporarily hardening light sources 208, in place of the temporarily hardening light sources 204 shown in FIG. 2 and so on. The individual temporarily hardening light sources 208 are installed at positions adjacent to the plurality of inkjet heads 202y to 202k in the main scan direction, respectively.

Also, in the configuration shown in FIG. 5(a), the plurality of inkjet heads 202y to 202k perform main scan operations, for example, on both of a predetermined forward path and backward path in the main scan direction. Also, the temporarily hardening light sources 208 are installed on both sides of each of the plurality of inkjet heads 202y to 202k in the main scan direction. Further, during a main scan operation, weak ultraviolet light is radiated by the temporarily hardening light sources 208 which are positioned on the rear side in the movement direction of the inkjet heads. Also, in this case, it is possible to radiate ultraviolet light after ink dots sufficiently flatten, for example, by appropriately setting a distance in the main scan direction between the temporarily hardening light sources 208 and the inkjet heads. In this way, it is possible to more appropriately flatten ink dots.

Also, the plurality of inkjet heads 202y to 202k may perform a main scan operation, for example, on only one of the forward path and the backward path in the main scan direction. In this case, the temporarily hardening light sources 208 may be installed only on one side of each of the plurality of inkjet heads 202y to 202k in the main scan direction.

Also, similarly to the temporarily hardening light sources 204 of the configuration shown in FIG. 2, the intensity of ultraviolet light which is radiated by the temporarily hardening light sources 208 is set to be lower than the intensity of ultraviolet light which is radiated by the fully hardening light source 206. Also, in this case, it is more preferable to set the intensity of ultraviolet light which is radiated by the temporarily hardening light sources 208 such that the corresponding intensity becomes equal to or lower than the intensity of ultraviolet light which is radiated by the temporarily hardening light sources 204 of FIG. 2. Even in the present modification, it is possible to temporarily harden ultraviolet curing ink on a medium by radiating weak ultraviolet light by the temporarily hardening light sources 208.

Also, even in the present modification, printing may be performed in the multi-pass mode. In this case, ink dots which are formed during each printing pass are temporarily hardened before a main scan operation of the next printing pass on the same position is performed. According to this configuration, for example, even with respect to ink dots of the same color, it is possible to more appropriately prevent connection of dots and the like from occurring. Therefore, it is possible to more appropriately uniformize the shapes of ink dots.

Even in the present modification, the inkjet heads 202y to 202k are arranged such that printing is performed in the color-sequential mode, similarly in the configuration described with reference to FIG. 2 and so on. For this reason, even if printing is performed in a multi-pass mode, it is unnecessary to consider, for example, intercolor bleeding. Therefore, it is possible to appropriately reduce the number of printing passes, as compared to a case of ejecting ink drops of all the colors in each main scan operation, for example, like an inkjet printer according to the related art. Also, it is possible to appropriately reduce the intensity of ultraviolet light which is radiated by the temporarily hardening light sources 208. Therefore, even in the present modification, it becomes possible to more easily and appropriately set the intensity of ultraviolet light which is radiated by the temporarily hardening light sources 208 in order to temporarily harden ink dots, within a practical range. Therefore, even in the present modification, for example, it is possible to more appropriately perform high-quality printing.

FIG. 5(b) shows a second modification of the configuration of the ink dot former 12. In the present modification, the ink dot former 12 has a plurality of temporarily hardening light sources 208, in addition to the temporarily hardening light sources 204 shown in FIG. 2 and so on. Similarly in the configuration shown in FIG. 5(a), the temporarily hardening light sources 208 are installed at positions adjacent to the plurality of inkjet heads 202y to 202k in the main scan direction, respectively.

Even in this case, it is possible to appropriately perform temporal hardening on ultraviolet curing ink on a medium by irradiating the ink with weak ultraviolet light by the temporarily hardening light sources 204 and the temporarily hardening light sources 208. Also, in this case, since ink is irradiated with ultraviolet light by the temporarily hardening light sources 208, and then is further irradiated with ultraviolet light by the temporarily hardening light sources 204, it is possible to further reduce the intensity of ultraviolet light which is radiated with the temporarily hardening light sources 208. Therefore, for example, even in a case of performing printing in a multi-pass mode, it becomes possible to more easily and appropriately set the intensity of ultraviolet light which is radiated by the temporarily hardening light sources 208 within a practical range. Therefore, even in the present modification, for example, it is possible to more appropriately perform high-quality printing.

Also, with respect to the intensity of ultraviolet light which is radiated by each of the ultraviolet light sources, for example, it is preferable to set the ratio of the intensity “A” of ultraviolet light which is radiated by the temporarily hardening light sources 208, the intensity “B” of ultraviolet light which is radiated by the temporarily hardening light sources 204, and the intensity “C” of ultraviolet light which is radiated by the fully hardening light source 206, such that, for example, the relation of about 10 to 20:20 to 60:100 is satisfied. According to this configuration, for example, with respect to ultraviolet curing ink on a medium, it is possible to more appropriately perform temporal hardening and fully hardening.

With reference to FIGS. 1(a), 1(b) to 5, the configuration in the case of performing printing with ultraviolet curing ink of all the colors in the color-sequential mode has been described. However, in order to appropriately perform temporal hardening on ink dots, it is not necessarily needed to perform printing with respect to all the colors in the color-sequential mode, and for example, it can also be considered to reduce the number of colors of ink dots which are formed in each main scan operation. Now, with respect to this case, modifications of the ink dot former 12 will be shown.

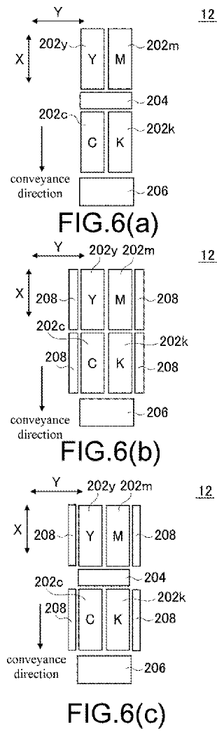

FIG. 6(a)-FIG. 6(c) show other modifications of the configuration of the ink dot former 12. Also, in FIG. 6(a)-FIG. 6(c), components denoted by the same reference symbols as those of FIGS. 1 to 5 have features identical or similar to the components of FIGS. 1(a), 1(b) to 5, except for points to be described below. Also, the configurations shown in FIG. 6(a)-FIG. 6(c), the inkjet head 202y is an example of the first-color head. The inkjet head 202c is an example of the second-color head. Also, the inkjet head 202m is an example of a third-color head. The inkjet head 202k is an example of a fourth-color head.

FIG. 6(a) shows a third modification of the configuration of the ink dot former 12. In the present modification, the plurality of inkjet heads 202y to 202k is divided into two groups each of which includes inkjet heads corresponding to two colors. Further, inkjet heads included in a group are installed such that their positions do not overlap inkjet heads included in the other group in the sub scan direction.

More specifically, in the configuration shown in FIG. 6(a), the inkjet head 202y and the inkjet head 202m are included in a first group. Also, the inkjet head 202c and the inkjet head 202k are included in a second group. Further, the inkjet head 202y and the inkjet head 202c are installed side by side in the sub scan direction, such that they are aligned in the main scan direction and their positions in the sub scan direction do not overlap each other. Also, the inkjet head 202m is aligned in the sub scan direction, and is installed side by side with the inkjet head 202y in the main scan direction. The inkjet head 202k is aligned in the sub scan direction, and is installed side by side with the inkjet head 202c in the main scan direction.

Further, in the present modification, the ink dot former 12 has a temporarily hardening light source 204 between the inkjet head 202y and the inkjet head 202m which are inkjet heads of the first group and the inkjet head 202c and the inkjet head 202k which are inkjet heads of the second group. Also, the ink dot former has the fully hardening light source 206 on the downstream side from the inkjet heads of the second group in the medium conveyance direction.

Also, according to these components, onto each position on a medium, the inkjet head 202y and the inkjet head 202m ejects ink drops of the Y color and the M color in a main scan operation which is determined according to the corresponding position on the medium. After the inkjet head 202y and the inkjet head 202m eject ink drops of the Y color and the M color, in another main scan operation, the inkjet head 202c and the inkjet head 202k eject ink drops of the C color and the K color, respectively. Also, after the inkjet head 202y and the inkjet head 202m eject ink drops of the Y color and the M color, with respect to each position of the medium, the temporarily hardening light sources 204 harden the ultraviolet curing ink of the Y color and the M color on the medium to the temporarily hardened state before the inkjet head 202c and the inkjet head 202k eject ink drops of the C color and the K color. Thereafter, the inkjet head 202c and the inkjet head 202k eject ink drops of the C color and the K color onto the area where the ultraviolet curing ink of the Y color and the M color has hardened to the temporarily hardened state.

According to this configuration, for example, it is possible to appropriately reduce the number of colors of ink dots which are formed in each main scan operation. Therefore, even in this case, it is possible to make it difficult for intercolor bleeding to occur, as compared to a case of ejecting ink drops of all the colors in each main scan operation. Therefore, even in the present modification, for example, with respect to ink dots which are formed on a medium, it is possible to appropriately perform temporal hardening. Therefore, for example, it is possible to appropriately perform high-quality printing.

Also, the number of groups into which the inkjet heads are divided is not limited to 2, and may be, for example, 3 or greater. Also, the number of colors of ink which is used in printing is not limited to the four colors of C, M, Y, and K, and may be a greater number. For example, more generally, with respect to a case of using ultraviolet curing ink of N-number of colors, it can be considered to divide the N-number of colors into k-number of groups each of which includes one or more colors (wherein k is an integer equal to or greater than 2 and less than N, for example, 2 or 3). In this case, inkjet heads for ejecting ink drops of the N-number of colors are installed, for example, such that their positions in the sub scan direction do not overlap each other in each group.

FIG. 6(b) shows a fourth modification of the configuration of the ink dot former 12. Also, the configuration of the present modification has features identical or similar to those of the configuration shown in FIG. 6(a), except for points to be described below.

In the present modification, the ink dot former 12 has a plurality of temporarily hardening light sources 208, in place of the temporarily hardening light sources 204 shown in FIG. 6(a). The individual temporarily hardening light sources 208 are installed at positions adjacent to the inkjet heads included in the individual groups, in the main scan direction. Therefore, in each main scan operation, the temporarily hardening light sources 208 temporarily harden ink dots formed in the corresponding main scan operation. Even in the present modification, for example, with respect to ink dots which are formed on a medium, it is possible to appropriately perform temporal hardening. Therefore, for example, it is possible to appropriately perform high-quality printing.

Also, even in a case of performing printing in a multi-pass mode, according to the present modification, for example, it is possible to appropriately reduce the number of colors of ink dots which are formed in a band area corresponding to each printing pass. Therefore, even in this case, for example, similarly to the configuration shown in FIG. 5(a), it becomes possible to more easily and appropriately set the intensity of ultraviolet light which is radiated by the temporarily hardening light sources 208, within a practical range.

Further, in the configuration of the present modification, for example, in a case of performing printing in a multi-pass mode, it is possible to temporarily harden ink dots whenever a main scan operation corresponding to each printing pass is performed. Therefore, according to the present modification, for example, with respect to a plurality of colors which is produced by a plurality of inkjet heads included in the same group, it is possible to appropriately prevent intercolor bleeding from occurring. Also, in the case of performing printing in a multi-pass mode, it is preferable to perform printing such that, during the same printing pass, ink drops of different colors are not ejected onto any of the same pixel and adjacent pixels in the main scan direction. According to this configuration, for example, it is possible to more appropriately prevent intercolor bleeding.

FIG. 6(c) shows a fifth modification of the configuration of the ink dot former 12. Also, the configuration of the present modification has features identical or similar to those of the configurations shown in FIG. 6(a) and FIG. 6(b), except for points to be described below.

In the present modification, the ink dot former 12 further includes temporarily hardening light sources 208 at positions adjacent to the inkjet heads of the individual groups in the main scan direction, in addition to a temporarily hardening light source 204 which is installed between the inkjet heads of the individual groups in the sub scan direction. Even in this case, for example, similarly to the cases described in association with the above described individual modifications, with respect to ink dots which are formed on a medium, it is possible to appropriately perform temporal hardening. Therefore, for example, it is possible to appropriately perform high-quality printing.

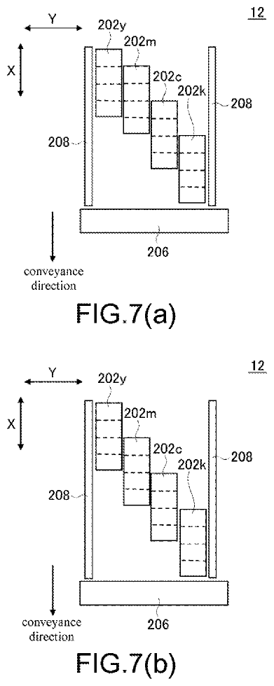

Now, with respect to a configuration for reducing the number of colors of ink dots which are formed in the same area in each main scan operation, other modifications will be shown. FIG. 7(a) and FIG. 7(b) show other modifications of the ink dot former 12. Also, in FIG. 7(a) and FIG. 7(b), components denoted by the same reference symbols as those of FIGS. 1(a), 1(b) to 4 have features identical or similar to the components of FIGS. 1(a), 1(b) to 4, except for points to be described below. Also, in the configurations shown in FIG. 7(a) and FIG. 7(b), the inkjet head 202y is an example of the first-color head. The inkjet head 202m is an example of the second-color head. Also, the inkjet head 202c is an example of the third-color head. The inkjet head 202k is an example of the fourth-color head.

FIG. 7(a) shows a sixth modification of the configuration of the ink dot former 12. FIG. 7(b) shows a seventh modification of the configuration of the ink dot former 12. In these modifications, the printing apparatus 10 (see FIG. 1(a) and FIG. 1(b)) performs printing in a multi-pass mode. Also, the inkjet heads 202y to 202k are installed such that their positions in the sub scan direction partially overlap adjacent inkjet heads in the main scan direction while their positions in the sub scan direction are deviated from each other by a pass width or more. In this case, the pass width is the width of one printing pass in the sub scan direction.

Also, more specifically, in the modifications shown in FIG. 7(a) and FIG. 7(b), the inkjet heads 202y to 202k are installed side by side in the main scan direction so as to be sequentially deviated from each other by a distance which is the product of the pass width and an integer. For example, in FIG. 7(a) and FIG. 7(b), the width of each of areas into which the insides of the inkjet heads 202y to 202k are divided by broken lines represents a pass width. More specifically, in FIG. 7(a) and FIG. 7(b), with respect to four areas into which each of the inkjet heads 202y to 202k is divided by broken lines, a pass width is the width of each area in the X direction. Further, in case of the configuration shown in FIG. 7(a), the inkjet heads 202y to 202k are installed such that their positions in the sub scan direction are sequentially deviated from each other by a distance equal to a pass width. Also, in case of the configuration shown in FIG. 7(b), the inkjet heads 202y to 202k are installed such that their positions in the sub scan direction are sequentially deviated from each other by a distance equal to twice a pass width (a distance corresponding to two passes). According to these configurations, for example, it is possible to appropriately reduce the number of colors of ink dots which are formed in a band area corresponding to each printing pass, in each main scan operation.

Also, in each modification shown in FIG. 7(a) and FIG. 7(b), the ink dot former 12 has temporarily hardening light sources 208 on both sides of the inkjet heads 202y to 202k in the main scan direction. Therefore, even in this case, it becomes possible to more easily and appropriately set the intensity of ultraviolet light which is radiated by the temporarily hardening light sources 208, within a practical range, by reducing the number of colors of ink dots which are formed in each band area in each main scan operation. Therefore, even in these modifications, for example, it is possible to appropriately perform temporal hardening on ink dots which are formed in each main scan operation. Therefore, for example, it is possible to appropriately perform high-quality printing.

Also, with respect to the configurations shown in FIG. 7(a) and FIG. 7(b) and the like, as a more general case, for example, it can also be said a configuration in which N-number of inkjet heads for ejecting ink drops of different colors are installed such that the number of colors of ink dots which are formed in a band area corresponding to each printing pass in each main scan operation is smaller than N. In this case, the temporarily hardening light sources 208 harden ink dots formed at each position on a medium in each main scan operation, to the temporarily hardened state, before the next main scan operation on the same position is performed. Also, with respect to each position on the medium, after all main scan operations of ejecting ink drops onto the corresponding position are performed, the fully hardening light source 206 irradiates the corresponding position with ultraviolet light. According to this configuration, for example, it is possible to appropriately reduce the number of colors of ink dots which are formed in a band area corresponding to each printing pass, in each main scan operation, and appropriately perform high-quality printing.

Now, a more specific configuration of the inkjet heads 202y to 202k will be described in more detail. In each configuration described above, as each of the inkjet heads 202y to 202k, for example, an inkjet head identical or similar to a known inkjet head can be suitably used. Also, more specifically, for example, an inkjet head having nozzle rows in which a plurality of nozzles is arranged in line in the sub scan direction can be suitably used. Also, in this case, for example, a configuration in which each of the inkjet heads 202y to 202k has one nozzle row can be suitably used.

Also, other configurations such as a configuration in which each of the inkjet heads 202y to 202k has a plurality of nozzle rows can be considered. Now, the case where each of the inkjet heads 202y to 202k has a plurality of nozzle rows will be described in more detail.

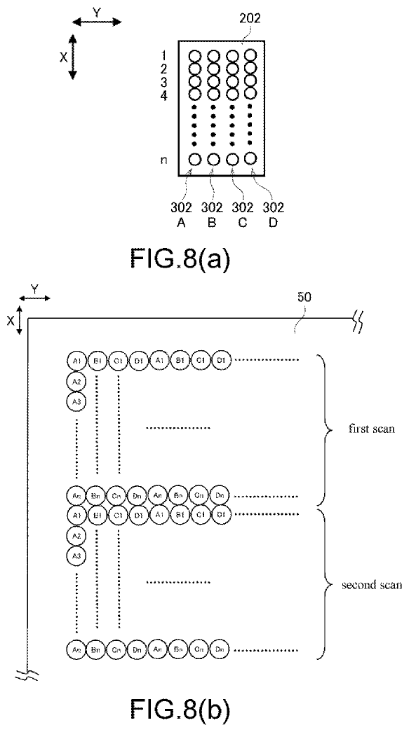

FIG. 8(a) and FIG. 8(b) are views for explaining examples of a configuration and an operation in a case of using inkjet heads 202 each of which has a plurality of nozzle rows 302. FIG. 8(a) shows an example of the configuration of an inkjet head 202. FIG. 8(b) shows an example of a printing operation which is performed using the inkjet head 202. Also, in FIG. 8(a) and FIG. 8(b), components denoted by the same reference symbols as those of FIGS. 1(a) to 7(b) have features identical or similar to the components of FIGS. 1(a) to 7(b), except for points to be described below. Further, the inkjet head 202 of FIG. 8(a) and FIG. 8(b) is an inkjet head corresponding to each of the inkjet heads 202y to 202k of FIGS. 1(a) to 7(b).

As shown in FIG. 8(a), in this case, the inkjet head 202 has a plurality of nozzle rows 302 each having a plurality of nozzles arranged in line in the sub scan direction. Also, the plurality of nozzle rows 302 is arranged side by side in the main scan direction. More specifically, in the case shown in the drawing, the inkjet head 202 has four nozzle rows 302 distinguished by attaching reference symbols “A” to “D” in the drawing. Also, in each nozzle row 302, n-number of nozzles denoted by numbers “1” to “n” are arranged in line.

Therefore, in this configuration, for example, as shown in FIG. 8(b), in each main scan operation, it is possible to eject ink drops from the plurality of nozzle rows 302 onto an area of a medium 50 on which the corresponding main scan operation is performed. Therefore, according to this configuration, for example, by one main scan operation, it is possible to perform printing identical or similar to printing which is performed by as many printing passes as the number of the nozzle rows.

Further, in FIG. 8(b), A1 to An represent ink dots which are formed by the first to n-th nozzles of a nozzle row 302 which is the A row. Also, similarly, B1 to Bn represent ink dots which are formed by the first to n-th nozzles of a nozzle row 302 which is the B row. C1 to Cn represent ink dots which are formed by the first to n-th nozzles of a nozzle row 302 which is the C row. D1 to Dn represent ink dots which are formed by the first to n-th nozzles of a nozzle row 302 which is the D row. Also, portions shown as a first scan portion and a second scan portion represent areas on which printing is performed in different main scan operations between which a sub scan operation is performed, respectively.

Also, in FIG. 8(b), for convenience of illustration, with respect to a case where the width of a band area is set to be equal to the length of the nozzle rows, printing states during the first scan and the second scan are shown. However, even in the case of using the inkjet head 202 having the plurality of nozzle rows 302, printing may be performed in a multi-pass mode.

For example, in the configuration in which the number of nozzle rows is four, it can be considered to perform printing in a multi-pass mode in which the number of printing passes is two. According to this configuration, for example, by one nozzle row, it is possible to perform printing similar to the case where printing is performed by eight printing passes. Also, for example, in the configuration in which the number of nozzle rows is four, it can be considered to perform printing in a multi-pass mode in which the number of printing passes is four. According to this configuration, for example, by one nozzle row, it is possible to perform printing similar to the case where printing is performed by sixteen printing passes.

Although the disclosure has been described above by way of the embodiment, the technical scope of the disclosure is not limited to the scope described in the embodiment. It is apparent to those skilled in the art that it is possible to make various changes or modifications in the above described embodiment. It is apparent from a description of claims that forms obtained by making such changes or modifications can also be included in the technical scope of the disclosure.

### INDUSTRIAL APPLICABILITY

The disclosure can be suitably used, for example, in printing apparatuses.

1. A printing apparatus which performs printing on a medium with an ultraviolet curing ink of N-number of different colors in an inkjet mode, where N is an integer of 2 or greater, and the printing apparatus comprising:
an ink dot former, performing printing on the medium by forming ink dots corresponding to individual pixels of a print image on the medium;
a main scan driver configured to drive inkjet heads of the ink dot former to perform main scan operations of ejecting ink drops while moving in a predetermined main scan direction; and
a sub scan driver configured to relatively move the inkjet heads of the ink dot former with respect to the medium in a sub scan direction perpendicular to the main scan direction,
wherein the ink dot former at least comprises:
a first-color head that is an inkjet head configured to eject first-color ink drops which are ink drops of the ultraviolet curing ink of a first color of the N-number of colors;
a second-color head which is an inkjet head configured to eject second-color ink drops which are ink drops of the ultraviolet curing ink of a second color which is one of the N-number of colors and is different from the first color;
a first temporarily hardening light source configured to radiate an ultraviolet light which hardens the ultraviolet curing ink on the medium to a temporarily hardened state which is a state where at least a surface of the ultraviolet curing ink has viscosity;
a plurality of second temporarily hardening light sources, configured to radiate the ultraviolet light which hardens the ultraviolet curing ink on the medium to the temporarily hardened state which is the state where at least the surface of the ultraviolet curing ink has viscosity; and
a fully hardening light source configured to radiate the ultraviolet light which completes hardening of the ultraviolet curing ink on the medium,
wherein the main scan driver is configured to drive the first-color head and second-color head to perform main scan operations,
the sub scan driver is configured to move the first-color head and second-color head with respect to the medium in the sub scan direction,
wherein the first-color head and the second-color head are installed such that their positions are deviated from each other along the sub scan direction,
wherein the first temporarily hardening light source is disposed between the first-color head and the second-color head in the sub scan direction, and the first temporarily hardening light source is installed such that its position in the sub scan direction doesn't overlap with either the first-color head or the second-color head,
each of the second temporarily hardening light sources is installed at a position adjacent to the corresponding inkjet head in the main scan direction,
the fully hardening light source is disposed on a downstream from any one of the first-color head, the first temporarily hardening light source and the second-color head in a direction in which the medium is moved with respect to the ink dot former in parallel with the sub scan direction, and
with respect to each position on the medium, after the first-color head ejects the first-color ink drops, the first temporarily hardening light source hardens the ultraviolet curing ink of the first color on the medium, to the temporarily hardened state, before the second-color head ejects the second-color ink drops,
the second-color head ejects the second-color ink drops onto an area where the ultraviolet curing ink of the first color has hardened to the temporarily hardened state, and
with respect to each position on the medium, after the second-color ink drops are ejected, the fully hardening light source radiates the ultraviolet light,
the first temporarily hardening light source radiates low-intensity ultraviolet light which does not fully harden ink, onto the ultraviolet curing ink ejected onto the medium by the inkjet head installed on an upstream side from the first temporarily hardening light source in a medium conveyance direction, and
the temporarily hardened state is a state where the ultraviolet curing ink does not repel liquid ink of different colors without occurrence of bleeding;
wherein the printing apparatus performs printing in a multi-pass mode for performing printing on each position on the medium by a plurality of printing passes, and
the printing apparatus performs printing in the multi-pass mode such that ink drops of different colors are not ejected onto any of the same pixel and adjacent pixels in the main scan direction in the same printing pass,
wherein the first-color head, the first temporarily hardening light source and the second-color head are arranged in line in the sub scan direction in this order, and
the first-color head, the first temporarily hardening light source and the second-color head have a same width in the main scan direction.

2. The printing apparatus according to claim 1, wherein
the first-color head and the second-color head are installed such that their positions in the sub scan direction are deviated from each other by a distance equal to or longer than a width of one printing pass in the sub scan direction.

3. The printing apparatus according to claim 2, wherein
printing is performed in the multi-pass mode such that ink drops are not ejected onto adjacent pixels in the main scan direction by the same printing pass.

4. The printing apparatus according to claim 1, wherein
the first temporarily hardening light source waits for ink dots which are formed by the first-color ink drops having landed on the medium to flatten, and then harden the ultraviolet curing ink of the first color to the temporarily hardened state.

5. The printing apparatus according to claim 1, wherein
the first-color head and the second-color head are installed side by side in the sub scan direction such that their positions in the sub scan direction do not overlap each other.

6. The printing apparatus according to claim 5, further comprising:
a third-color head that is an inkjet head configured to eject third-color ink drops which are ink drops of the ultraviolet curing ink of a third color different from both of the first color and the second color; and
a fourth-color head that is an inkjet head configured to eject fourth-color ink drops which are ink drops of the ultraviolet curing ink of a fourth color different from all of the first color, the second color, and the third color,
wherein the third-color head is aligned in the sub scan direction, and is installed side by side with the first-color head in the main scan direction,
the fourth-color head is aligned in the sub scan direction, and is installed side by side with the second-color head in the main scan direction,
with respect to each position on the medium, the first-color head and the third-color head eject the first-color ink drops and the third-color ink drops, respectively, in a main scan operation which is determined according to the position on the medium, and after the first-color head and the third-color head eject the first-color ink drops and the third-color ink drops, in another main scan operation, the second-color head and the fourth-color head eject the second-color ink drops and the fourth-color ink drops, respectively,
with respect to each position on the medium, after the first-color head and the third-color head eject the first-color ink drops and the third-color ink drops, the first temporarily hardening light source hardens the ultraviolet curing ink of the first color and the ultraviolet curing ink of the third color on the medium, to the temporarily hardened state, before the second-color head and the fourth-color head eject the second-color ink drops and the fourth-color ink drops, and
the second-color head and the fourth-color head eject the second-color ink drops and the fourth-color ink drops onto an area where the ultraviolet curing ink of the first color and the third color has hardened to the temporarily hardened state.

7. The printing apparatus according to claim 1, further comprising:
a third-color head that is an inkjet head configured to eject third-color ink drops which are ink drops of the ultraviolet curing ink of a third color different from both of the first color and the second color; and
a fourth-color head that is an inkjet head configured to eject fourth-color ink drops which are ink drops of the ultraviolet curing ink of a fourth color different from all of the first color, the second color, and the third color,
wherein the printing apparatus performs printing in a multi-pass mode for performing printing on each position on the medium by a plurality of printing passes, and
the first-color head, the second-color head, the third-color head, and the fourth-color head are installed in this order, side by side in the main scan direction, such that their positions in the sub scan direction are sequentially deviated from each other by a distance which is a product of an integer and a pass width which is a width of one printing pass in the sub scan direction.

8. The printing apparatus according to claim 1, wherein
an intensity of the ultraviolet light which the first temporarily hardening light source radiates is lower than an intensity of the ultraviolet light which the fully hardening light source radiates.

9. The printing apparatus according to claim 1, wherein
the N-number of colors are divided into k-number of groups, where k is an integer equal to or greater than 2 and less than N, each of which includes one or more colors, and
inkjet heads for ejecting ink drops of colors included in each group are installed such that their positions do not overlap inkjet heads for ejecting ink drops of colors included in the other groups, in the sub scan direction.

10. The printing apparatus according to claim 1, wherein
each of the first-color head and the second-color head has a plurality of nozzle rows, in each of which a plurality of nozzles is arranged in line in the sub scan direction.

11. A printing method of performing printing on a medium with an ultraviolet curing ink of N-number of different colors in an inkjet mode, where N is an integer of 2 or greater and the printing method using:
a first-color head that is an inkjet head configured to eject first-color ink drops which are ink drops of the ultraviolet curing ink of a first color of the N-number of colors;
a second-color head which is an inkjet head configured to eject second-color ink drops which are ink drops of the ultraviolet curing ink of a second color which is one of the N-number of colors and is different from the first color;
a main scan driver configured to drive the first-color head and the second-color head to perform main scan operations of ejecting ink drops while moving in a predetermined main scan direction;
a sub scan driver configured to relatively move the first-color head and the second-color head with respect to the medium in a sub scan direction perpendicular to the main scan direction;
a first temporarily hardening light source configured to radiate an ultraviolet light which hardens the ultraviolet curing ink on the medium to a temporarily hardened state which is a state where at least a surface of the ultraviolet curing ink has viscosity;
a plurality of second temporarily hardening light sources, configured to radiate the ultraviolet light which hardens the ultraviolet curing ink on the medium to the temporarily hardened state which is the state where at least the surface of the ultraviolet curing ink has viscosity, and each of the second temporarily hardening light sources is installed at a position adjacent to the corresponding inkjet head in the main scan direction; and
a fully hardening light source configured to radiate the ultraviolet light which completes hardening of the ultraviolet curing ink on the medium,
wherein the first-color head and the second-color head are installed such that their positions in the sub scan direction are deviated from each other,
with respect to each position on the medium, the first-color head ejects the first-color ink drops in one of the main scan operations which is determined according to the position on the medium, and after the first-color head ejects the first-color ink drops, in another main scan operation, the second-color head ejects the second-color ink drops,
with respect to each position on the medium, after the first-color head ejects the first-color ink drops, the first temporarily hardening light source hardens the ultraviolet curing ink of the first color on the medium, to the temporarily hardened state, before the second-color head ejects the second-color ink drops,
the second-color head ejects the second-color ink drops onto an area where the ultraviolet curing ink of the first color has hardened to the temporarily hardened state, and
with respect to each position on the medium, after the second-color ink drops are ejected, the fully hardening light source radiates the ultraviolet light.

12. A printing apparatus which performs printing on a medium with an ultraviolet curing ink of N-number of different colors in an inkjet mode, where N is an integer of 2 or greater and the printing apparatus comprising:
N-number of inkjet heads configured to eject ink drops of the ultraviolet curing ink of the N-number of colors, respectively;
a main scan driver configured to drive the N-number of inkjet heads to perform main scan operations of ejecting ink drops while moving in a predetermined main scan direction;
a sub scan driver configured to relatively move the N-number of inkjet heads with respect to the medium in a sub scan direction perpendicular to the main scan direction;
a first temporarily hardening light source configured to radiate an ultraviolet light which hardens the ultraviolet curing ink on the medium to a temporarily hardened state which is a state where at least a surface of the ultraviolet curing ink has viscosity;
a plurality of second temporarily hardening light sources, configured to radiate the ultraviolet light which hardens the ultraviolet curing ink on the medium to the temporarily hardened state which is the state where at least the surface of the ultraviolet curing ink has viscosity, and each of the second temporarily hardening light sources is installed at a position adjacent to the corresponding inkjet head in the main scan direction; and
a fully hardening light source configured to radiate the ultraviolet light which completes hardening of the ultraviolet curing ink on the medium,
wherein the printing apparatus performs printing in a multi-pass mode for performing printing on each position on the medium by a plurality of printing passes,
the N-number of inkjet heads are installed such that the number of colors of ink dots which are formed in a band area corresponding to each printing pass in each main scan operation is smaller than N,
with respect to ink dots formed at each position on the medium in each main scan operation, the first temporarily hardening light source hardens the ink dots to the temporarily hardened state before the next main scan operation on the same position is performed, and
with respect to each position on the medium, after all main scan operations of ejecting ink drops onto the corresponding position are performed, the fully hardening light source radiates the ultraviolet light.

13. The printing apparatus according to claim 2, wherein
the first temporarily hardening light source waits for ink dots which are formed by the first-color ink drops having landed on the medium to flatten, and then harden the ultraviolet curing ink of the first color to the temporarily hardened state.

14. The printing apparatus according to claim 3, wherein
the first temporarily hardening light source waits for ink dots which are formed by the first-color ink drops having landed on the medium to flatten, and then harden the ultraviolet curing ink of the first color to the temporarily hardened state.

15. The printing apparatus according to claim 2, wherein
the first-color head and the second-color head are installed side by side in the sub scan direction such that their positions in the sub scan direction do not overlap each other.

16. The printing apparatus according to claim 3, wherein
the first-color head and the second-color head are installed side by side in the sub scan direction such that their positions in the sub scan direction do not overlap each other.

17. The printing apparatus according to claim 2, further comprising:
a third-color head that is an inkjet head configured to eject third-color ink drops which are ink drops of the ultraviolet curing ink of a third color different from both of the first color and the second color; and
a fourth-color head that is an inkjet head configured to eject fourth-color ink drops which are ink drops of the ultraviolet curing ink of a fourth color different from all of the first color, the second color, and the third color,
wherein the printing apparatus performs printing in a multi-pass mode for performing printing on each position on the medium by a plurality of printing passes, and
the first-color head, the second-color head, the third-color head, and the fourth-color head are installed in this order, side by side in the main scan direction, such that their positions in the sub scan direction are sequentially deviated from each other by a distance which is a product of an integer and a pass width which is a width of one printing pass in the sub scan direction.

18. The printing apparatus according to claim 3, further comprising:
a third-color head that is an inkjet head configured to eject third-color ink drops which are ink drops of the ultraviolet curing ink of a third color different from both of the first color and the second color; and
a fourth-color head that is an inkjet head configured to eject fourth-color ink drops which are ink drops of the ultraviolet curing ink of a fourth color different from all of the first color, the second color, and the third color,
wherein the printing apparatus performs printing in a multi-pass mode for performing printing on each position on the medium by a plurality of printing passes, and
the first-color head, the second-color head, the third-color head, and the fourth-color head are installed in this order, side by side in the main scan direction, such that their positions in the sub scan direction are sequentially deviated from each other by a distance which is a product of an integer and a pass width which is a width of one printing pass in the sub scan direction.
